(19) United States
(12) Patent Application Publication
(10) Pub. No.: US 2021/0064725 A1
(43) Pub. Date: Mar. 4, 2021

(54) GENERATING AND UTILIZING A DIGITAL PASS WITH USER VERIFICATION AND AUTOFILL FORMATTED DATA

(71) Applicant: Comenity LLC, Columbus, OH (US)

(72) Inventors: Ryan MILLER, Columbus, OH (US); Chris ANDERSON, Columbus, OH (US)

(73) Assignee: Comenity LLC, Columbus, OH (US)

(21) Appl. No.: 16/730,414

(22) Filed: Dec. 30, 2019

Related U.S. Application Data
(60) Provisional application No. 62/891,889, filed on Aug. 26, 2019.

(51) Int. Cl. G06F 21/31; G06Q 20/36; G06Q 20/32; G06F 40/174

(52) U.S. Cl. CPC G06F 21/31; G06F 40/174; G06Q 20/3278; G06Q 20/36

(57) ABSTRACT

A system and method for generating and utilizing a digital pass with user verification and autofill formatted data is disclosed. Initially, a request is received for the digital pass to be generated for a user. The request includes identification (ID) information that is added to a database. An image is defined for the digital pass, the image incorporating at least a portion of the ID information therein and being editable only by the digital pass management system. The digital pass, which includes the image and a non-image portion that is editable by the user, is generated. At least a portion of the ID information is autofill formatted ID information for utilization with at least some portion of an application. The digital pass is transmitted to the user's mobile device.

### CROSS-REFERENCE TO RELATED APPLICATIONS (PROVISIONAL)

This application claims priority to and benefit of co-pending U.S. Provisional Patent Application No. 62/891,889 filed on Aug. 26, 2019, entitled “DIGITAL PASS WITH USER VERIFICATION” by Miller et al., and assigned to the assignee of the present application, the disclosure of which is hereby incorporated herein by reference in tis entirety.

### BACKGROUND

It is often difficult for a customer to track and/or remember one's personal information. Such personal information includes their own (and sometimes friends and family members) birthday(s), phone numbers, address(es), social security number(s), driver's license number(s), license plate number(s), size(s) in different clothing/shoes, favorite brands, etc. This difficulty is further exacerbated when the information is requested at a time when, or a place where, the customer does not have ready access thereto.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a mobile device, in accordance with an embodiment.

FIG. 2 is a block diagram of a digital pass management system, in accordance with an embodiment.

FIG. 3 is a mock-up diagram of a digital pass as presented on a display screen of a mobile device, in accordance with an embodiment.

FIG. 4 is a flowchart of a method for generating a digital pass with user verification, in accordance with an embodiment.

FIG. 5 is a flowchart of a method for generating a digital pass with user verification, and formatting ID information for auto filling in accordance with an embodiment.

FIG. 6 is a flowchart of a method for generating a digital pass with user verification, formatting ID information for auto filling, and using the data to autofill an application in accordance with an embodiment.

FIG. 7 is a block diagram of an example computer system with which or upon which various embodiments of the present invention may be implemented.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope as defined by the appended claims. In some embodiments, all or portions of the electronic computing devices, units, and components described herein are implemented in hardware, a combination of hardware and firmware, a combination of hardware and computer-executable instructions, or the like. In one embodiment, the computer-executable instructions are stored in a non-transitory computer-readable storage medium. Furthermore, in the following description, numerous specific details are set forth in order to provide a thorough understanding of the subject matter. However, some embodiments may be practiced without these specific details. In other instances, well-known methods, procedures, objects, and circuits have not been described in detail as not to unnecessarily obscure aspects of the subject matter.

### NOTATION AND NOMENCLATURE

Unless specifically stated otherwise as apparent from the following discussions, it is appreciated that throughout the present Description of Embodiments, discussions utilizing terms such as “selecting”, “outputting”, “allowing,” “limiting,” “issuing,” “preventing,” “inputting”, “providing”, “receiving”, “utilizing”, “obtaining”, “performing”, “accessing”, “authorizing” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

It should be appreciated that the obtaining, accessing, or utilizing of information conforms to applicable privacy laws (e.g., federal privacy laws, state privacy laws, etc.).

Embodiments described herein provide a novel method for adding a digital pass to a mobile wallet on a user's mobile device. The digital pass includes a digital capture of a user's sizing information (e.g., a sizing card), style information, preference information, things that they liked, etc., that would be stored on a digital pass in a customer's mobile device's mobile wallet. In one embodiment, the user could open the digital pass to retrieve and/or update the user's sizing information. For example, if the user was looking for a pair of shoes, they could look at the shoe sizing on the digital pass and determine that they had previously purchased (or tried on) a size 10. This information is especially valuable in the Internet shopping environment where it is impossible to try the shoe on, or when the user was buying a shoe for someone else who is not presently available to try on the shoe. Although a shoe is used, the example could be for any sizing or preference information such as, but not limited to, clothing, jewelry, paint color, furnishings, electronics, vehicles and/or accessories, and the like.

Importantly, the embodiments of the present invention, as will be described below, provide an approach for digital pass utilization which differs significantly from the conventional processes used to store sizing information and provide user identification verification. In conventional approaches, the sizing information was not electronically available, updatable, or presentable as part of a mobile wallet. In addition, the use of an image on the pass used to store and provide user ID and/or device ID information were not interchangeable. As such, it was likely that a customer would not have a digital pass that included both user editable and user non-editable information. Further, the embodiments described herein provide a digital pass that includes information associated therewith that is updateable (up to and including) each time the digital pass is accessed.

Thus, the present embodiments described herein, require a completely new and different system which is completely different than what was previously done because of the Internet-centric centralized aspect of the mobile wallet digital pass.

As will be described in detail, the various embodiments of the present invention do not merely implement conventional processes on a mobile device. Instead, the various embodiments of the present invention, in part, provide a novel process for storing, presenting, and utilizing user editable and non-editable information in a digital pass of a mobile wallet which is necessarily rooted in Internet-centric computer technology to overcome a problem specifically arising in the realm of digital pass technology.

Moreover, the embodiments do not recite a mathematical algorithm; nor do they recite a fundamental economic or longstanding commercial practice. Instead, they address a business challenge that has been born in the Internet-centric environment. Thus, the embodiments do not merely recite the performance of some business practice known from the pre-Internet world along with the requirement to perform it on a computing device. Instead, the embodiments are necessarily rooted in network-centric environments in order to overcome new problems specifically arising in the realm of digital passes.

### Operation

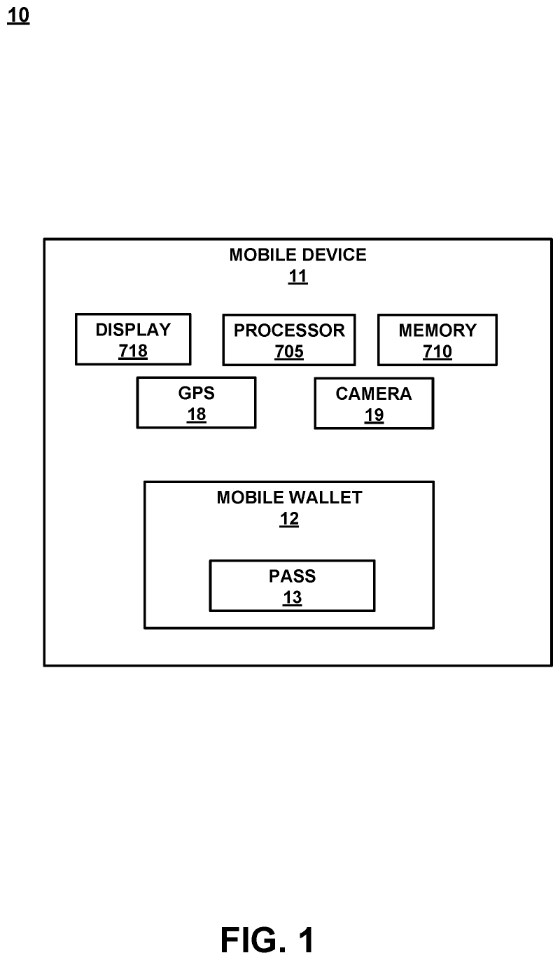

Referring now to FIG. 1, a block diagram 10 of a mobile device 11 is shown. Although a number of components are shown as part of mobile device 11, it should be appreciated that other, different, more, or fewer components may be found on mobile device 11.

In general, mobile device 11 is an example of a customer's mobile device, a store's mobile device, an associate's mobile device, or the like. Mobile device 11 could be a mobile phone, a smart phone, a tablet, a smart watch, a piece of smart jewelry, smart glasses, or other user portable devices having wireless connectivity. For example, mobile device 11 would be capable of broadcasting and receiving via at least one network, such as, but not limited to, WiFi, Cellular, Bluetooth, NFC, and the like. In one embodiment, mobile device 11 includes a display 718, a processor 705, a memory 710, a GPS 18, a camera 19, and the like. In one embodiment, instead of providing GPS information, the location of mobile device 11 may be determined within a given radius, such as the broadcast range of an identified beacon, a WiFi hotspot, overlapped area covered by a plurality of mobile telephone signal providers, or the like.

Mobile device 11 also includes a digital or mobile wallet 12 (passbook, or the like) which is an electronic application that operates on mobile device 11. Mobile wallet 12 includes digital pass 13. Although digital pass 13 is shown as part of mobile wallet 12, it should be appreciated that digital pass 13 could be located in a different application operating on mobile device 11, or stored elsewhere such as part of an email, text, or the like.

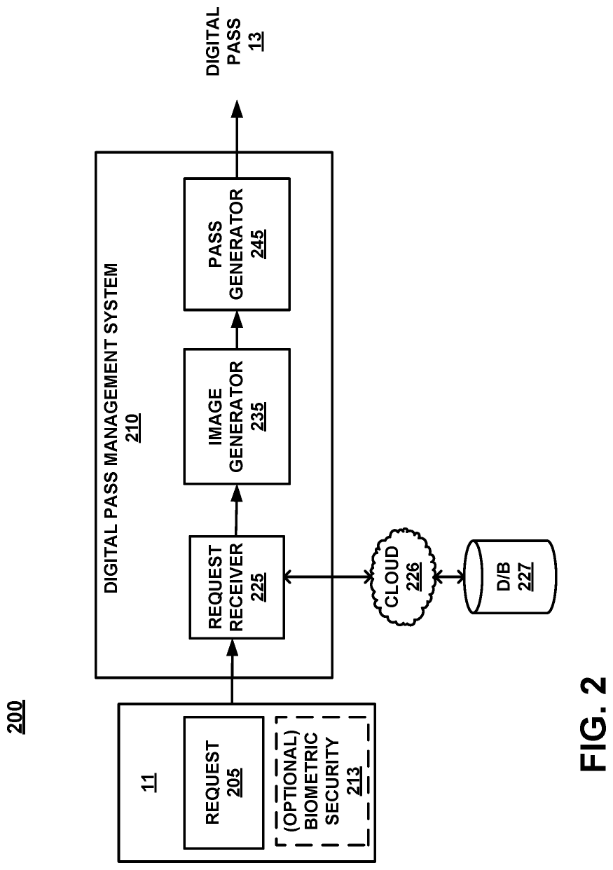

With reference now to FIG. 2, a block diagram of a system 200 for digital pass with user verification creation is shown in accordance with an embodiment. FIG. 2 includes mobile device 11, digital pass management system 210, cloud 226, database 227, and digital pass 13.

In one embodiment, mobile device 11 includes a request 205 and an optional biometric security 213. Request 205 is a request for digital pass with user verification that will include user preference information 310. Optional biometric security 213 can be any user biometrics such as, voice, image, print, or other user identifiable biometric that can be used to provide security, a decryption key, or the like.

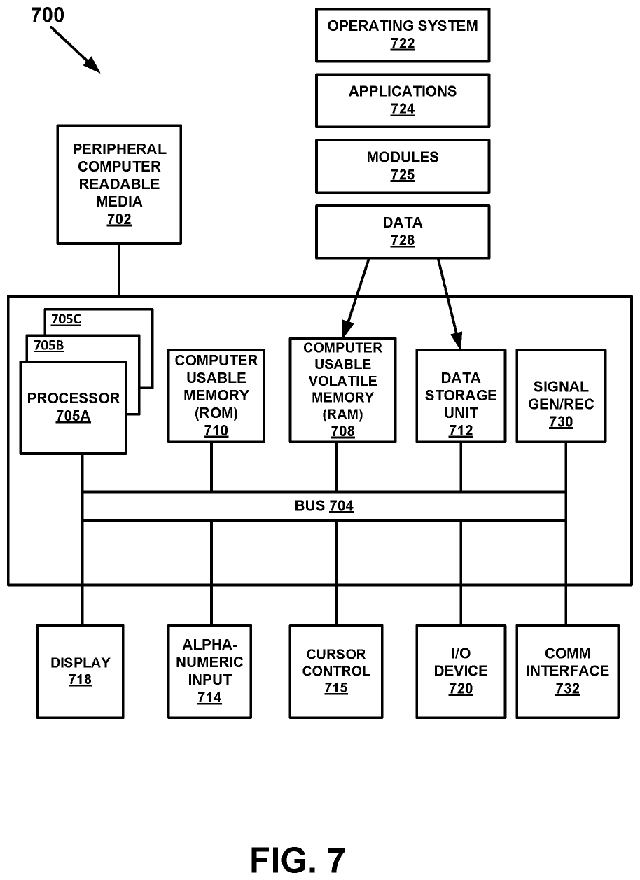

In one embodiment, digital pass management system 210 is a computing system such as computer system 700 described in detail in the FIG. 7 herein. In one embodiment, digital pass management system 210 includes a request receiver 225, an image generator 235, and a digital pass generator 245.

In one embodiment, digital pass management system 210 receives the request 205 for a digital pass 130 to be added to the customer's mobile wallet 12 at request receiver 225. In one embodiment, the request 205 includes user ID information and/or mobile device ID information. In general, a mobile device ID can include one or more identification characteristics such as: a telephone number or portion thereof, a serial number or portion thereof, an international mobile equipment identity (IMEI) or portion thereof, an integrated circuit card identifier (ICCID) (e.g., the SIM card number) or portion thereof, a mobile equipment identifier (MEID) or portion thereof, a secure element chipset identify (SEID) or portion thereof, a media access control (MAC) address or portion thereof, an Internet protocol (IP) address or portion thereof, a universal unique identifier (UUID) or portion thereof, a model number or portion thereof, a product number or portion thereof, a serial number or portion thereof, or the like.

User ID can be information such as: a name, a zip code, a social security number or portion thereof, a driver's license number or portion thereof, a birth date, and the like that can be used to identify a specific user.

In one embodiment, the request 205 is received by the digital pass management system 210 from mobile device 11 via the cloud, mobile network, WiFi, or the like. In another embodiment, digital pass management system 210 receives the request 205 from a website that has been accessed by mobile device 11 (e.g., via the cloud, WiFi, mobile network, or the like).

In one embodiment, upon receiving request 205, request receiver 225 will access database 227 to build a user profile and store any received ID information in the user profile. In one embodiment, request receiver 225 accesses database 227 via cloud 226. An example of cloud 226 is a network such as the Internet, local area network (LAN), wide area network (WAN), or the like.

Database 227 could be a local database, a virtual database, a cloud database, a plurality of databases, or a combination thereof.

In one embodiment, database 227 can also stores a plurality of customer data files (such as credit accounts, reward accounts, and the like) and request receiver 225 could search database 227 for one or more existing data files that are held by the user as identified by the ID information included with the request. If any pre-existing data files are found, the received information would be compared/added/or otherwise tied to the existing customer data file.

Image generator 235 generates an image for the digital pass and incorporate at least a portion of the ID information and or autofill formatted ID information into the image. In one embodiment, the image is editable only by the digital pass management system 210. In one embodiment the image is a computer scannable image that is generated as an identifier for the customer data file (or to include at least some of the ID information). Although in one embodiment, an image is generated, it should be appreciated that there may be an identification scheme other than an image that is used. For example, the image is a scannable code, a near field communication (NFC) protocol, a sound, or the like. In one embodiment, the image includes a token embedded within the image data. In one embodiment, the image is provided via a near field communication (NFC) between the mobile device 11 and the information requestor when digital pass 13 is accessed. Thus, the use of an image is provided as one embodiment as an example of a means of providing encryption, security, or the like.

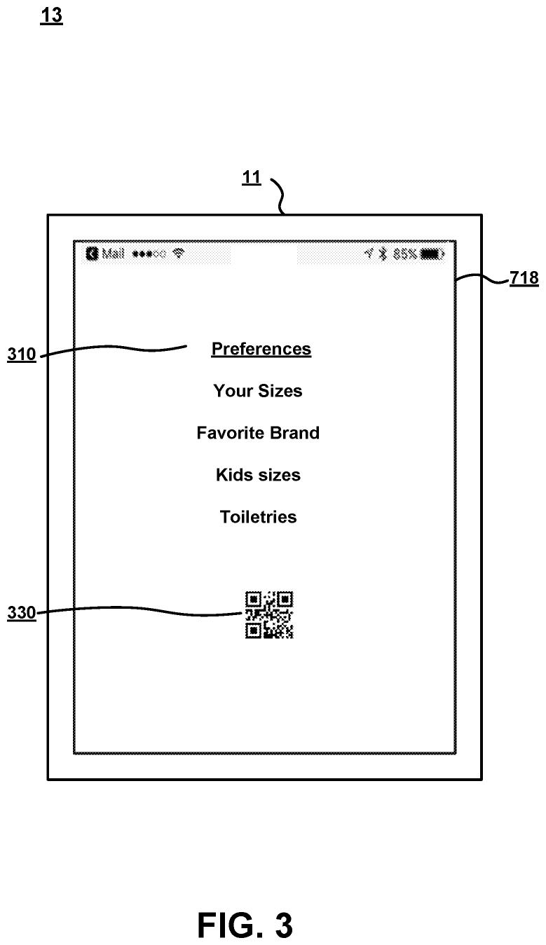

Digital pass generator 245 generates a digital pass 13 formatted for mobile wallet 129, the digital pass 13 including the image and a non-image portion that is editable by the user (as shown in FIG. 3). In one embodiment, digital pass 13 includes an instruction that causes the digital pass 130 to be presented in a first location of mobile wallet 129 on the customer's mobile device 11.

The digital pass 13 is then provided from the digital pass management system 210 to the customer's mobile device 11. The digital pass 13 is added to mobile wallet 129 on the customer's mobile device 11, wherein an access of the digital pass 13 in the mobile wallet causes the digital pass 130 to be presented by the customer's mobile device 11. As stated herein, the presentation of part of all of digital pass 13 could be visual (e.g., an image on the display screen), electronic (e.g., an NFC, Bluetooth, or similar electronic communications protocol), sound, or a combination thereof.

In one embodiment, the digital pass 13 is provided to mobile device 11 from pass generator 245 via a delivery method such as, but not limited to: a text, an email, a mobile push to a mobile wallet 12, via a network such as near field communication (NFC), Bluetooth, WiFi, or the like.

For example, the pass generator 245 will send a message to mobile device 11 which will include the digital pass 13 information such that the opening of the text message will result in the insertion of the digital pass 13 into mobile wallet 12. In a mobile push scenario, the pass generator 245 will push the digital pass 13 to mobile device 11.

With reference now to FIG. 3, a block diagram of a digital pass 13 as presented on a display 718 of a mobile device 11 is shown in accordance with an embodiment. Although a number of different features are shown in conjunction with the description of digital pass 13, it should be appreciated that some embodiments may include additional features or may skip some of the features altogether.

Digital pass 13 includes preference information 310 (e.g., a non-image portion that is editable by the user) and image 330. Preference information 310 can include

Image 330 is a scannable code, such as a barcode, QR code, code embedded in a video, 2D image code, 3D image code, or the like. Image 330 can be a static or dynamic image. For example, if the image 330 is a static image, the image 330 would be the same (or change only when updated) each time the digital pass 13 was opened. The image 330 would include static information such as user identifiers, account identifiers, device identifiers, autofill formatted ID information, or the like which would not be subject to changing very often (e.g., other than system updates, etc.).

In contrast, a dynamic image 330 could be changed (or adjusted) each time the digital pass 13 is opened by the user (or at a given time period, anytime a change to the stored information occurs, etc.). In one embodiment, the dynamic image 330 is requested from the digital pass management system 210 each time the digital pass 13 is accessed. That is, the image 330 would be provided from digital pass management system at the time of opening to ensure that image 330 is real-time up-to-date. In one embodiment, image 330 contains ID information that can be used to provide reliable and secure user identification information. For example, image 330 could be scanned or otherwise provided as part of an application process. By scanning the image 330, an authorized application process would be able to obtain some or all of the identification information accessible from image 330.

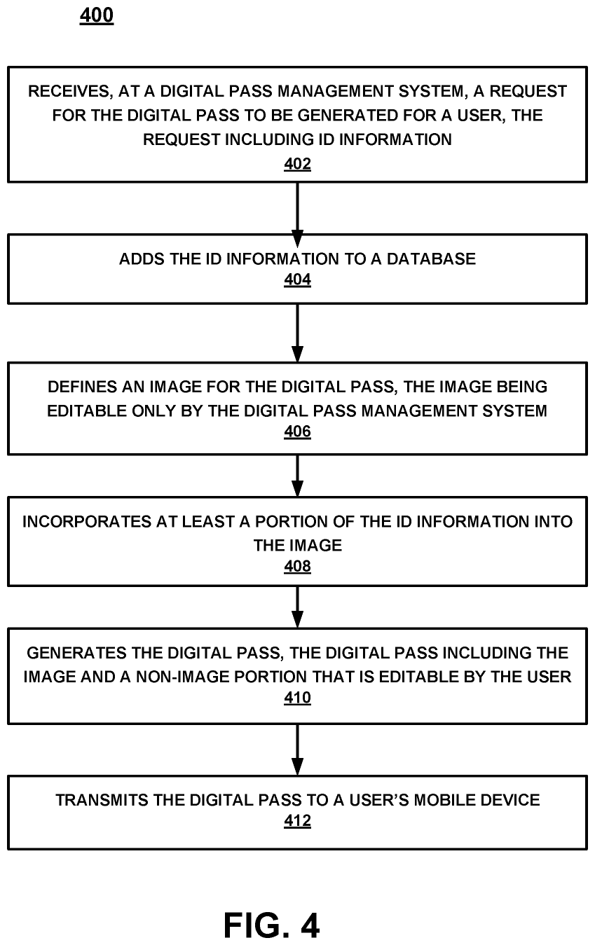

With reference now to FIG. 4, a flowchart 400 of a method for providing a digital pass 13 with user verification is shown in accordance with an embodiment.

Referring now to 402 of FIG. 4, one embodiment receives, at a digital pass management system 210, a request for the digital pass 13 to be generated for a user, the request including at least one of identification (ID) information and autofill formatted ID information. In one embodiment, the request for the digital pass 13 is received from the user's mobile device. In one embodiment, the request for the digital pass 13 is received from the user's computer system.

For purposes of clarity, in one embodiment, the mobile device 11 could be a mobile phone, a smart phone, a tablet, a smart watch, a piece of smart jewelry, smart glasses, or the like. In contrast, the user's computer system refers to any computing device such as a laptop, desktop, notebook, or other computer system that is not covered in the list of mobile devices (or the equivalents) provided above. Thus, for example, the request from a user's computer system could be a request from a home computer.

In one embodiment, the ID information includes at least a portion of two or more user identifiers from a group including, but not limited to, a name, an address, a zip code, a social security number, a driver's license number, a birth date, credit accounts, rewards accounts, and the like.

In one embodiment, the ID information includes at least a portion of each user identifier from the group including, but not limited to, a name, an address, a zip code, a social security number, a driver's license number, a birth date, and the like.

In one embodiment, the ID information includes at least a portion of two or more mobile device identifiers from a group including, but not limited to, a telephone number, a serial number, an IMEI, an ICCID, an MEID, an SEID, a MAC address, an IP address, a UUID, a model number, a product number, a serial number, and the like.

In one embodiment, the ID information includes at least a portion of each mobile device identifier from the group including, but not limited to, a telephone number, a serial number, an IMEI, an ICCID, an MEID, an SEID, a MAC address, an IP address, a UUID, a model number, a product number, a serial number, and the like.

With reference now to 404 of FIG. 4, one embodiment adds the ID information to a database 227. In one embodiment, the database is a secure database. In one embodiment, the database is part of a distributed system that includes a plurality of databases in a plurality of different locations. In one embodiment, the ID information is encrypted when it is added to the database. In one embodiment, in addition to the received ID information, additional identification information could be obtained from a retailer's computer system, a rewards account system, a credit account system, other information in the digital pass management system 210, or the like. In one embodiment, the additional information could be determined from the provided user ID and/or device ID information initially provided in the request 205. In one embodiment, once any related ID information is found, identified, etc. that information is added to the ID information stored in the database 227.

Referring now to 406 of FIG. 4, one embodiment defines an image 330 for the digital pass 13, the image 330 being editable only by the digital pass management system 210. For example, the information stored in the image 330 could be completely blocked from edit or adjustment by a user or other accessor of the mobile device 11. Instead, the information contained in the image 330 would be maintained by the digital pass management system 210 (or a retailer, database, credit account provider, clearinghouse, or the like).

If the user wanted to change the information stored in the image 330, the user would have to contact the information storage holder (e.g., digital pass management system 210) and provide a verifiable change. Moreover, if the user's address (or other user ID, device ID, account information, or the like) changes, the update to the information stored in the image 330 could be made without the user even knowing, or needing to act. As such, the information that is stored in the image 330 would have as high of a level of accuracy, encryption, safeguard, or the like, as desired. In so doing, when the information from the image 330 was used, it would be known to be maintained at a high level of accuracy and reliability.

With reference now to 408 of FIG. 4, one embodiment incorporates at least a portion of the ID information into the image 330. In one embodiment, it is a link to the ID information in the database that is incorporated into the image 330.

In one embodiment, the mobile device ID information that is incorporated into image 330 is determined based upon an evaluation of which of the possible mobile device ID's would provide the best capability for fraud prevention. For example, a user's phone number could be easily obtained (e.g., via social media, public records, white pages, Internet search, etc.) so it would be a lower mobile device ID option on a fraud scale. In contrast, the mobile device's serial number, IMEI, ICCID, MEID, SEID, or the like is much less likely to be obtained fraudulently (via social media, public records, guessed, etc.) so it may be that one of the IMEI, ICCID, MEID, SEID, or the like would be the mobile device ID requested due to the higher fraud prevention value.

In one embodiment, the user ID information that is incorporated into image 330 is determined based upon an evaluation of which of the possible user ID's would provide the best capability for fraud prevention. For example, a user's birthday could be easily obtained (e.g., via social media, public records, etc.) so it would be a lower user ID option on a fraud scale. Similarly, a user's address could be easily obtained (e.g., via social media, public records, etc.) so it would also be a lower user ID option on a fraud scale. Further, a user's email could be easily obtained (e.g., via social media, public records, etc.) or easily guessed, so it would also be a lower user ID option on a fraud scale. In contrast, a social security number (or last four, six, seven, five, middle three, five, first 6, 7; middle three+last two; or any other amount or combination of the nine social security numbers) is much less likely to be obtained fraudulently (e.g., via social media, public records, guessed, etc.) so it may be that a pre-selected portion of the SSN (or a changing selected portion of the SSN) would be the user ID with the highest fraud prevention value.

In one embodiment, the image is updateable as the ID information changes. For example, once any related ID information is found, identified, etc. that information is added to the ID information stored in the database 227. Moreover, some or all of the related information could be added to the information referenced by image 330. Thus, an update to the user information file (such as an identification of a reward account and the addition of the reward account information added to the user information file in the database 227) would likely cause the information identified by the image 330 to need to be updated. The updated image could include updated user ID information, credit information, rewards points, and the like.

Referring now to 410 of FIG. 4, one embodiment generates the digital pass 13, the digital pass 13 including the image 330 and a non-image portion (e.g., preference information 310) that is editable by the user. In one embodiment, the user editable non-image portion is user defined preference information 310 such as sizing, style, brand, manufacturer, etc.

In other words, in one embodiment, the information stored in the image 330 would have different access rights than the preference information 310 on the digital pass 13. For example, the preference information 310 could be edited by the user, by a sales associate, updated via an email, text, or the like. Thus, the ability to adjust the preference information 310 could be as easy or hard as the user desired. In one embodiment, the user could let the digital pass 13 be updated based on an email, text (or other communication) from someone that includes sizing information, brand information, a purchase request, etc. In a harder update scenario, the user could only allow an update to the preference information 310 with an edit, replacement, or the like actually performed on the user's device, performed by the user, etc.

In one embodiment, information such as a user's sizing information (e.g., a sizing card), style information, things that they liked, etc., would be stored in the preference information 310 of the digital pass 13 in a customer's mobile wallet 12. In one embodiment, the user could open the digital pass 13 to view the user's stored preference information 310. Thus, if the user was looking for a pair of shoes, they could look at the shoe sizing in the preference information 310 on the digital pass 13 and determine that they had previously purchased (or tried on) a size 10. As such, and especially in the Internet shopping environment where it is impossible to try the shoe on, the user would have a good idea of their present shoe size. In one embodiment, a store associate could provide the preference information 310 electronically from the associate's mobile device to the user's digital pass 13 based on a fitting/sizing/etc. In one embodiment, after purchase, the sizing information for the purchase could be electronically passed from the retailer to the preference information 310 on the user's digital pass 13. In one embodiment, the electronic passing of data could be via text, email, beacon, WiFi, Bluetooth, near field communications (NFC), or the like.

In addition to the user's own sizing information, the digital pass 13 could also include the preference information 310 for others know to the user. For example, preference information 310 could include a partner's information, a child's information, a friend's information, a friend's kid's information, a relative's information 310, etc. For example, a parent would be shopping and see kids' shoes on sale. The parent could open the digital pass 13 and look-up the child's shoe size in the preference information 310. In another example, a user could open the digital pass 13 and look to preference information 310 for the type (or brand) of washing machine detergent to purchase, the type of shampoo to buy, etc. Similarly, the user could text someone else about the unknown preference information 310 and then import the information (automatically or manually) into the preference information 310 portion of digital pass 13.

With reference now to 412 of FIG. 4, one embodiment transmits the digital pass 13 to a user's mobile device 11. In one embodiment, the digital pass 13 is automatically added to a mobile wallet 12 on the mobile device 11 when the digital pass 13 is received at the mobile device 11.

### User Verification

In one embodiment, the information contained in the image 330 is used to provide reliable and secure customer information. For example, when presenting a digital pass 13, the mobile wallet 12 will incorporate image 330 such as a brand logo, barcode, etc. However, instead of just showing a brand logo, barcode, or the like, the image 330 provided by the digital pass 13 can be a static or dynamic image. For example, if the image 330 is a static image, the image 330 would be the same (or change only when updated) each time the digital pass 13 was opened. The image 330 would include static information such as user identifiers, account identifiers, and the like which would not be subject to changing very often.

In contrast, a dynamic image on the digital pass 13 would be an image 330 that can be changed (or adjusted) each time (or at a given time period, anytime a change to the stored information occurs, etc.) the digital pass 13 is opened by the user. In one embodiment, the image 330 would be requested from the digital pass management system 210 when the digital pass 13 was initially accessed. The image 330 would be provided to the digital pass 13 at the time of opening to ensure that it is real-time up-to-date.

In one embodiment, mobile device 11 will receive a command to display the digital pass 13. Upon receipt of the command, mobile device 11 will submit an image 330 update request to digital pass management system 210. If there is an updated image 330, then digital pass management system 210 would provide the updated image 330 which would be received by mobile device 11 and amended to digital pass 13 for presentation. In one embodiment, if there is no updated image 330, mobile device 11 could receive the existing image 330 from digital pass management system 210, could receive an indication from digital pass management system 210 to display the existing image 330, or the like.

In one embodiment, digital pass management system 210 will receive an indication that the mobile device 11 has been asked to display the digital pass 13. Upon receipt of the indication, digital pass management system 210 could push an updated image 330 for the digital pass 13 to the mobile device 11.

For example, if the user is opening the digital pass 13 for a reward redemption, the image 330 that is presented on the digital pass 13 will be an image 330 that includes data that is presently relevant. E.g., the customer's real-time rewards balance (or offers, coupons, etc.). Thus, the image 330 presented on the digital pass 13 could be different each time the digital pass 13 is opened, or anytime the information provided by the digital pass 13 has changed. For example, if the customer used the digital pass 13 for reward points on a purchase yesterday (when the rewards points balance was 2,500 and the purchase gave the customer 200 points), when the customer opens the digital pass 13 today, the image 330 on the digital pass 13 would include information about the rewards points that include the new total rewards points balance (e.g., 2,700). Similarly, if the prior purchase caused a one-time 20% discount to be obtained in addition to the 200 new points, the new image 330 on the digital pass 13 would indicate both the new total rewards points balance (e.g., 2,700) as well as the available one-time 20% discount.

In one embodiment, when the image 330 on the digital pass 13 is scanned at a POS by an associate's mobile device, or the like, the image 330 would provide the customer's rewards, discounts, or the like.

The digital pass 13 could be used in conjunction with other components of the mobile device (such as location information, etc.). For example, when the digital pass 13 is opened by the user, the digital pass 13 would obtain the location of the mobile device. In one embodiment, that information would be used to identify that the user has entered a geofenced area such as a store, or the like. This location determination would trigger a message such as a text messages, an email, a URL, the initiation of other apps on the mobile device, or the like. The message would provide the user with information/offers/etc. relevant to the user's present location.

In one embodiment, when there is a change to the digital pass 13 (or information to be provided via the digital pass 13), an indication would occur in the mobile wallet 12. When the mobile wallet 12 indication was accessed by the user, the information that had been sent to the digital pass 13 would be presented to the customer: e.g., offers, coupons, sizing information, etc. Other reasons for an indication to be provided could include aspects such as, but not limited to, statuses or alerts regarding an account, disaster information in the person's area (payments in your region are waived this month due to a hurricane, etc.), notification of credit limit increase, a spectacular sale, an annual event, a birthday (or other date) reminder, and the like.

In one embodiment, the image 330 in the digital pass 13 can be used to provide two-factor authentication when the user applies for an account (credit, reward, etc.). The first factor would be the user interacting with the user's mobile device (e.g., thereby generating a user ID, device ID, etc.). The second factor would be the information stored in the image 330 of the digital pass 13 is what would be electronically obtained by the user's mobile device (or other computing device performing the application process). That information stored in the image 330 would be used to fill out the application. As such, the two factor authentication would provide a reduction in fraud since the two factor authentication would result in information being provided from a reliable source instead of unverified information being provided by a user.

For example, image 330 could be scanned or otherwise provided as part of an application process. By scanning the image 330, an authorized application process would be able to request or obtain some or all of the identification information accessible from image 330. For example, a user wants to apply for a credit account. The credit application process asks the user to present the digital pass 13 and then captures image 330 from the display screen (or a microphone, etc.). If the credit application process is pre-authorized, then it would be able to unlock some or all of at least one of the ID information and the autofill formatted ID information that is stored in image 330. The ID information and or autofill formatted ID information could then be designated as reliable (or somewhat reliable) information by the application process which could allow the information to be deemed as less risky (or more secure) than user keyed information. This could be important for customer status, credit limit establishment, fraud determination purposes, and the like.

In another example, a user wants to apply for a reward account. The reward application captures image 330 from the display screen (or a microphone, etc.). Instead of obtaining ID information stored within the image 330, the reward program would obtain a requesting channel and an identifier from the information that is stored in image 330. That is, a channel to contact digital pass management system 210 and identifier from the image that is linked to the underlying user and/or device ID in database 227. In one embodiment, digital pass management system 210 would verify that the digital pass 13 was accessed on the mobile device 11 and verify a validity of the information request (which could be a validation of the requestor, the machine from which the request was sent, the security profile of the machine making the request, a review of pirate databases, bad boy lists, etc., and the like.). Once the digital pass management system 210 had positively verified the access and the validity of the requestor, the digital pass management system 210 could provide some of the ID information and or autofill formatted ID information from database 227 to the reward program.

In so doing, the ID information received by the reward program can be designated as reliable (or somewhat reliable) information which could allow the information to be deemed as less risky (or more secure) than user keyed information. This could be important for customer status, fraud determination purposes, and the like.

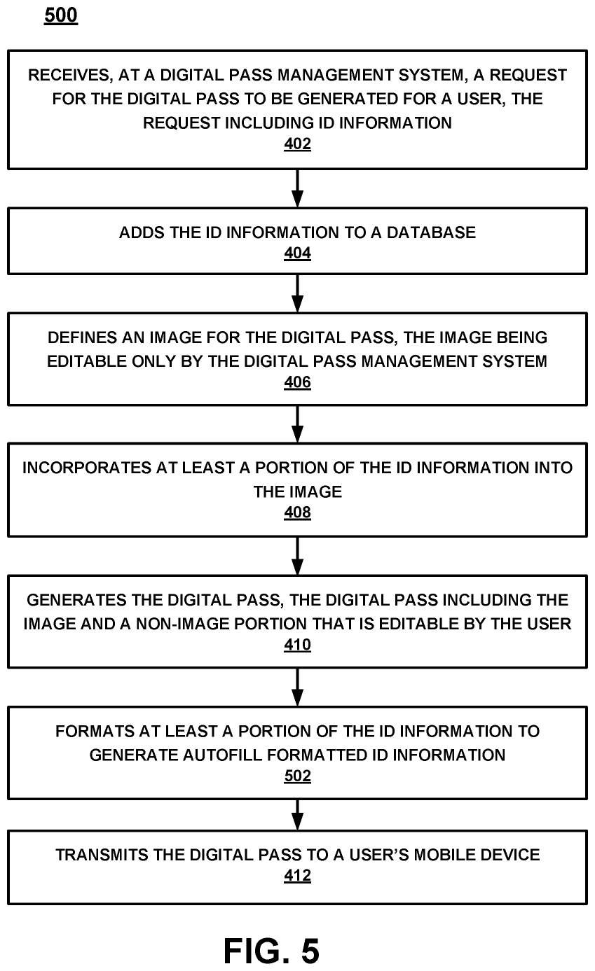

Referring now to flowchart 500 of FIG. 5, 402-412 operate in a manner similar or the same as described of in conjunction with the description of FIG. 4. For purposes of brevity and clarity the present application will not repeat a description of 402-412. At FIG. 5, in accordance with the present embodiment, as shown at 502, at least a portion of the ID information is formatted to generate autofill formatted ID information that is suitable for auto filling applications. In one embodiment, the ID information is formatted to generate autofill formatted ID information at the digital pass management system before the digital pass is transmitted to the user's mobile device as shown in FIG. 5. However, in another embodiment, the ID information is formatted to generate autofill formatted ID information by the user's mobile device, and after the digital pass is transmitted to the user's mobile device.

In one embodiment, the segments of the autofill formatted ID information are separated, parsed, or otherwise quantized such that the segments of the autofill formatted ID information are readily accessible as individual elements. For example, if one segment of the autofill formatted ID information is a user's full name, then the segment of the autofill formatted ID information is separated into multiple elements. For example, the ID information as generated or as generated or as described at 404 may include for example a user's name such as Jane B. Doe. However, in one embodiment of the present invention the ID information is formatted to generate autofill formatted ID information as follows. Rather than Jane B. Doe being a unified data entry the user's first name Jane is separated, parsed, or otherwise quantized such that it sits alone as an autofill formatted piece of ID information. Additionally, the user's middle initial B, in the present example, is also separated. Finally, Doe is also separated meaning that each element of the ID information in which previously comprised the user's name in its entirety has now been separated, parsed, or otherwise quantized into three discrete components, a first name, middle initial, and last name.

In one embodiment, the autofill formatted ID information is part of the scannable image 330 of the digital pass 13 where the image 330 is either static or dynamic.

In one embodiment the autofill formatted ID information is stored as text either as part of the digital pass 13 or as a separate secure pass. In another embodiment, the autofill formatted ID information is viewable and or editable at will by the user.

In another embodiment, the autofill formatted ID information is sharable through methods other than NFC such as, for example, Bluetooth, WiFi, or similar electronic communications protocol.

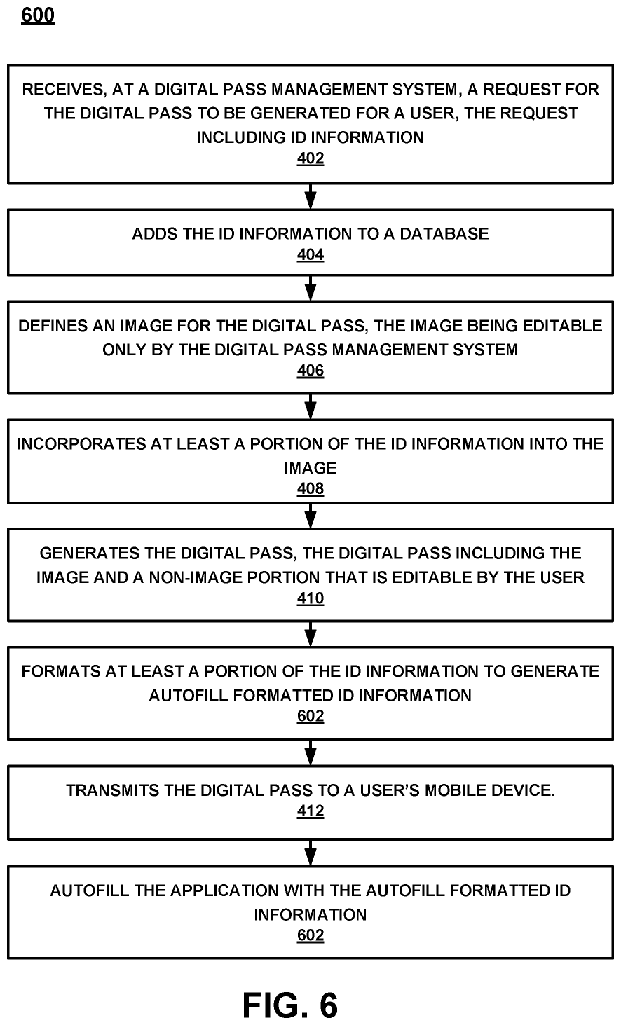

Referring now to FIG. 6, a flowchart 600 of a method for generating a digital pass with user verification, formatting ID information for auto filling, and using the data to autofill an application is shown in accordance with an embodiment. In the embodiment, 402-412 and 502 operate in a manner similar or the same as described of in conjunction with the description of FIGS. 4 and 5. For purposes of brevity and clarity the present application will not repeat a description of 402-412 and 502. In one embodiment as shown at 602, the autofill formatted ID information is used to autofill an application.

In one embodiment, there is an application which can be auto filled with information. For example, the application may request the user's first name. As discussed herein, by separating, parsing, or otherwise quantizing the user's name, for example Jane B. Doe, the user's first name will autofill as Jane, the middle initial as B, and the last name as Doe. Thus, the autofill formatted ID information is readily usable for auto filling an application.

In one embodiment the ID information consists of at least one of the user ID information and the device ID information. In general, auto fill applications relevant to the present embodiment may include for example credit card application, credit application, loyalty enrollment program, shipping information, billing information, and the like.

In one embodiment, upon the completion of any application (or at any point during the filling out of the application) the user would be prompted to securely store the provided information which would then generate the autofill formatted ID information as shown at 502, where it is then stored in their digital wallet as a secure pass to make prefilling this information faster in the future. This secure pass is either the digital pass 13 or a separate pass. In one embodiment, the autofill formatted ID information is generated after the digital pass 13 is received, with the information being taken either from the digital pass 13 or from the mobile device 11.

In one embodiment, the autofill formatted ID information is provided via methods other than NFC, such as Bluetooth, WiFi, or other electronic communication protocols.

In one embodiment, when the user chooses to share any of the autofill formatted ID information, they will see that there is an option for the application to be auto filled as determined by the fields that are being requested. At any point, they choose whether to allow or deny the sharing of one or more of the fields being requested either individually or as a whole. In one embodiment, portions of the stored data can be selected as being automatically provided to fill in a form, while other portions of the stored data can be selected to not be automatically provided to fill in a form. For example, the user could set the name preference to be auto filled. In one embodiment, the user could have a number of different emails and thus have the autofill provide an option window such that the user can select the desired email (e.g., a business email address, personal email address, spam email address, etc.) to be automatically filled. In one embodiment, the user could have other data such as social security number, credit card number, birthday, or other personal or confidential information that is never automatically provided but can be auto filled at the user's discretion. Although a number of examples are disclosed, the type of data that can be automatically provided, selected from a list, selectively provided, discretionally provided, and/or only manually provided can be based on user preferences, controlling rules/laws/statutes, predefined by the digital pass management system, or the like.

In one embodiment, the user is required to use a secure authentication process to use, edit, or access the autofill formatted ID information each time it is used, edited, or accessed such as Face ID, Touch ID, pin, password or OTP. In another embodiment the user has the option of turning off the secure authentication process and the user will use, edit, or access the autofill formatted ID information without the need for authentication.

In another embodiment if the request to autofill the application is denied by the user then the manually entered ID information is compared to the autofill formatted ID information. Should the manually entered information differ from the autofill formatted ID information, a prompt to update the autofill formatted ID information may be displayed. For example, if the user Jane B. Doe rejects the prompt to autofill the application and instead inputs the new name John B. Doe, then the user will receive a prompt asking if the previous autofill formatted ID information should be updated to match the new inputted information. In one embodiment, multiple versions of the autofill formatted ID information are stored simultaneously and the prompt to update the autofill formatted ID information includes the option of storing a second set of autofill formatted ID information. In which case, the next time an application is to be filled out then the user will choose between the autofill options of Jane B. Doe and John B. Doe.

In one embodiment, assume a brand would like to collect a user's information, such as their email, zip code or phone number, for a loyalty enrollment program. Should the user choose to share the information with the brand, they will do so by for example tapping their phone to an NFC terminal. The user will then configure what information to share by using an app or the NFC terminal. In one embodiment, the user chooses to pass all fields which is then done via a static NFC pass. It should be noted that while in this embodiment the autofill formatted ID information is shared via a static NFC pass, as stated above other transfer methods are ready to be utilized for example Bluetooth, WiFi, or similar electronic communications protocol.

In one embodiment, assume for example a brand notices a user's interest in the brands products. The brand then sends a request for the autofill formatted ID information to the user's mobile device, or other device on which the user has the autofill formatted ID information, and with the user's permission automatically enroll the user in the loyalty program or a similar program. In one embodiment, the request sent by the brand is some form of electronic communication for example text, email, an app notification, or the like.

### Example Computer System

With reference now to FIG. 7, portions of the technology for providing a communication composed of computer-readable and computer-executable instructions that reside, for example, in non-transitory computer-readable medium (or storage media, etc.) of a computer system. That is, FIG. 7 illustrates one example of a type of computer that can be used to implement embodiments of the present technology. FIG. 7 represents a system or components that may be used in conjunction with aspects of the present technology. In one embodiment, some or all of the components described herein may be combined with some or all of the components of FIG. 7 to practice the present technology.

FIG. 7 illustrates an example computer system 700 used in accordance with embodiments of the present technology. It is appreciated that computer system 700 of FIG. 7 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 7, computer system 700 of FIG. 7 is well adapted to having peripheral computer readable media 702 such as, for example, a disk, a compact disc, a flash drive, and the like coupled thereto.

Computer system 700 of FIG. 7 includes an address/data/control bus 704 for communicating information, and a processor 705A coupled to bus 704 for processing information and instructions. As depicted in FIG. 7, computer system 700 is also well suited to a multi-processor environment in which a plurality of processors 705A, 705B, and 705C are present. Conversely, computer system 700 is also well suited to having a single processor such as, for example, processor 705A. Processors 705A, 705B, and 705C may be any of various types of microprocessors. Computer system 700 also includes data storage features such as a computer usable volatile memory 708, e.g., random access memory (RAM), coupled to bus 704 for storing information and instructions for processors 705A, 705B, and 705C.

Computer system 700 also includes computer usable non-volatile memory 710, e.g., read only memory (ROM), coupled to bus 704 for storing static information and instructions for processors 705A, 705B, and 705C. Also present in computer system 700 is a data storage unit 712 (e.g., a magnetic disk drive, optical disk drive, solid state drive (SSD), and the like) coupled to bus 704 for storing information and instructions. Computer system 700 also can optionally include an alpha-numeric input device 714 including alphanumeric and function keys coupled to bus 704 for communicating information and command selections to processor 705A or processors 705A, 705B, and 705C. Computer system 700 also can optionally include a cursor control device 715 coupled to bus 704 for communicating user input information and command selections to processor 705A or processors 705A, 705B, and 705C. Cursor control device may be a touch sensor, gesture recognition device, and the like. Computer system 700 of the present embodiment can optionally include a display 718 coupled to bus 704 for displaying information.

Referring still to FIG. 7, display 718 of FIG. 7 may be a liquid crystal device, cathode ray tube, OLED, plasma display device or other display device suitable for creating graphic images and alpha-numeric characters recognizable to a user. Cursor control device 715 allows the computer user to dynamically signal the movement of a visible symbol (cursor) on display 718. Many implementations of cursor control device 715 are known in the art including a trackball, mouse, touch pad, joystick, non-contact input, gesture recognition, voice commands, bio recognition, and the like. In addition, special keys on alpha-numeric input device 714 capable of signaling movement of a given direction or manner of displacement. Alternatively, it will be appreciated that a cursor can be directed and/or activated via input from alpha-numeric input device 714 using special keys and key sequence commands.

Computer system 700 is also well suited to having a cursor directed by other means such as, for example, voice commands. Computer system 700 also includes an I/O device 720 for coupling computer system 700 with external entities. For example, in one embodiment, I/O device 720 is a modem for enabling wired or wireless communications between computer system 700 and an external network such as, but not limited to, the Internet or intranet. A more detailed discussion of the present technology is found below.

Referring still to FIG. 7, various other components are depicted for computer system 700. Specifically, when present, an operating system 722, applications 724, modules 725, and data 728 are shown as typically residing in one or some combination of computer usable volatile memory 708, e.g. random-access memory (RAM), and data storage unit 712. However, it is appreciated that in some embodiments, operating system 722 may be stored in other locations such as on a network or on a flash drive; and that further, operating system 722 may be accessed from a remote location via, for example, a coupling to the internet. In one embodiment, the present technology, for example, is stored as an application 724 or module 725 in memory locations within RAM 708 and memory areas within data storage unit 712. The present technology may be applied to one or more elements of described computer system 700.

Computer system 700 also includes one or more signal generating and receiving device(s) 730 coupled with bus 704 for enabling computer system 700 to interface with other electronic devices and computer systems. Signal generating and receiving device(s) 730 of the present embodiment may include wired serial adaptors, modems, and network adaptors, wireless modems, and wireless network adaptors, and other such communication technology. The signal generating and receiving device(s) 730 may work in conjunction with one (or more) communication interface 732 for coupling information to and/or from computer system 700. Communication interface 732 may include a serial port, parallel port, Universal Serial Bus (USB), Ethernet port, Bluetooth, thunderbolt, near field communications port, WiFi, Cellular modem, or other input/output interface. Communication interface 732 may physically, electrically, optically, or wirelessly (e.g., via radio frequency) couple computer system 700 with another device, such as a mobile phone, radio, or computer system.

Computer system 700 is only one example of a suitable computing environment and is not intended to suggest any limitation as to the scope of use or functionality of the present technology. Neither should the computing environment be interpreted as having any dependency or requirement relating to any one or combination of components illustrated in the example computer system 700.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method for generating and utilizing a digital pass with user verification and autofill formatted data, the method comprising:
receiving, at a digital pass management system, a request for the digital pass to be generated for a user,
the request comprising: identification (ID) information;
adding the ID information to a database;
defining an image for the digital pass, the image being editable only by the digital pass management system;
incorporating at least a portion of the ID information into the image;
generating the digital pass, the digital pass comprising:
the image; and
a non-image portion that is editable by the user;
formatting at least a portion of said ID information to generate autofill formatted ID information, said autofill formatted ID information configured for an application that requires at least some portion of said ID information;
transmitting the digital pass to a mobile device of the user; and
auto filling said application with said autofill formatted ID information.

2. The method of claim 1, further comprising:
receiving the request for the digital pass from the mobile device.

3. The method of claim 1, further comprising:
receiving the request for the digital pass from a user's computer system.

4. The method of claim 1, further comprising:
automatically adding the digital pass to a mobile wallet on the mobile device when the digital pass is received at the mobile device.

5. The method of claim 1, where the ID information comprises at least a portion of two or more user identifiers from a group consisting of: a name, an address, a zip code, a social security number, a driver's license number, and a birth date.

6. The method of claim 1, where the ID information comprises at least a portion of each user identifier from a group consisting of: a name, an address, a zip code, a social security number, a driver's license number, and a birth date.

7. The method of claim 1, where the ID information comprises at least a portion of two or more mobile device identifiers from a group consisting of: a telephone number, a serial number, an international mobile equipment identity (IMEI), an integrated circuit card identifier (ICCID), a mobile equipment identifier (MEID), a secure element chipset identify (SEID), a media access control (MAC) address, an Internet protocol (IP) address, a universal unique identifier (UUID), a model number, a product number, and a serial number.

8. The method of claim 1, where the ID information comprises at least a portion of each mobile device identifier from a group consisting of: a telephone number, a serial number, an international mobile equipment identity (IMEI), an integrated circuit card identifier (ICCID), a mobile equipment identifier (MEID), a secure element chipset identify (SEID), a media access control (MAC) address, an Internet protocol (IP) address, a universal unique identifier (UUID), a model number, a product number, and a serial number.

9. The method of claim 1, wherein the application is selected from the group consisting of a credit card application, a credit application, a loyalty enrollment program, a shipping information, and a billing information.

10. The method of claim 1 further comprising:
a prompt to store at least a portion of said autofill formatted ID information within a mobile wallet as a near field communication (NFC) pass upon completion of said application.

11. A non-transitory computer-readable medium for storing instructions, the instructions comprising:
one or more instructions which, when executed by one or more processors, cause one or more processors to:
receive a request at a digital pass management system for a digital pass to be generated for a user,
the request comprising: identification (ID) information;
add the ID information to a database;
generate an image for the digital pass, the image being editable only by the digital pass management system;
incorporate at least a portion of the ID information into the image;
generate the digital pass, the digital pass comprising:
the image; and
a non-image portion that is editable by the user;
format at least a portion of said ID information to generate autofill formatted ID information, said autofill formatted ID information configured for an application that requires at least some portion of said ID information;
transmit the digital pass to a mobile device of the user; and
auto fill said application with said autofill formatted ID information.

12. The non-transitory computer-readable medium of claim 11, where the one or more instructions further cause one or more processors to:
receive, at the digital pass management system, an indication that the mobile device is preparing to display the digital pass; and
push an updated image for the digital pass to the mobile device.

13. The non-transitory computer-readable medium of claim 11, where the one or more instructions further cause one or more processors to:
automatically add the digital pass to a mobile wallet on the mobile device when the digital pass is received at the mobile device.

14. The non-transitory computer-readable medium of claim 11, where the ID information comprises at least a portion of three or more mobile device identifiers from a group consisting of: a telephone number, a serial number, an international mobile equipment identity (IMEI), an integrated circuit card identifier (ICCID), a mobile equipment identifier (MEID), a secure element chipset identify (SEID), a media access control (MAC) address, an Internet protocol (IP) address, a universal unique identifier (UUID), a model number, a product number, and a serial number.

15. The non-transitory computer-readable medium of claim 11, where the one or more instructions further cause one or more processors to:
receive, at the digital pass management system, an information request for at least some of the ID information contained in the image;
verify that the digital pass was accessed on the mobile device;
verify an identity of a party that provided the information request; and
provide, upon positive verification of the mobile device and the identity, the at least the portion of the ID information.

16. The non-transitory computer-readable medium of claim 11, where the request for the digital pass is received from a user's computer system.

17. A system comprising:
a digital pass management system comprising:
a memory;
a storage; and
one or more processors to:
receive a request for a digital pass to be generated for a user,
the request comprising:
a user identification (ID) information, and
a device ID information;
add the user ID information and the device ID information to a database;
develop an image for the digital pass, the image being editable only by the digital pass management system;
link the image to the user ID information and the device ID information in the database;
generate the digital pass, the digital pass comprising:
the image; and
a non-image portion that is editable by the user;
format at least a portion of said ID information to generate autofill formatted ID information, said autofill formatted ID information configured for an application that requires at least some portion of said ID information; and
send the digital pass to a mobile device of the user; and
the mobile device comprising:
a display;
a mobile device memory;
a mobile device storage; and
one or more mobile device processors to:
provide the request for the digital pass to be generated for the user;
receive the digital pass;
automatically add the digital pass to a mobile wallet on the mobile device; and
automatically auto fill at least a portion of said application with said autofill formatted ID information.

18. The system of claim 17 where the one or more processors of the digital pass management system are further to:
receive an information request for at least some of the ID information linked to the image;
verify that the digital pass was accessed on the mobile device;
verify a validity of the information request; and
provide, upon positive verification of the mobile device and the validity, the at least some of the ID information.

19. The system of claim 17 where the one or more processors of the digital pass management system are further to:
receive an indication that the mobile device is preparing to display the digital pass; and
push an updated image for the digital pass to the mobile device.

20. The system of claim 17 where the one or more mobile device processors are further to:
receive a command to display the digital pass on the display;
submit an image update request to the digital pass management system;
receive an updated image; and
display the digital pass with the updated image.
